(19) United States
(12) Patent Application Publication
(10) Pub. No.: US 2017/0087603 A1
(43) Pub. Date: Mar. 30, 2017

(54) Thread Cleaner System

(71) Applicant: David Fleegle, Bedford, PA (US)

(72) Inventor: David Fleegle, Bedford, PA (US)

(21) Appl. No.: 14/865,809

(22) Filed: Sep. 25, 2015

(51) Int. Cl. B08B 9/02; B08B 1/00

(52) U.S. Cl. CPC B08B 9/021; B08B 1/005

(57) ABSTRACT

A thread cleaner system for cleaning threads in a compression fitting includes a compression fitting. A cleaner is removably inserted into the compression fitting. The cleaner may be rotated when the cleaner is removably inserted into the compression fitting. Thus, the cleaner may clean the compression fitting. The shaft portion is coupled to and extends away from the second end.

### BACKGROUND OF THE DISCLOSURE

Field of the Disclosure

The disclosure relates to cleaner devices and more particularly pertains to a new cleaner device for cleaning threads in a compression fitting.

### SUMMARY OF THE DISCLOSURE

An embodiment of the disclosure meets the needs presented above by generally comprising a compression fitting. A cleaner is removably inserted into the compression fitting. The cleaner may be rotated when the cleaner is removably inserted into the compression fitting. Thus, the cleaner may clean the compression fitting. The shaft portion is coupled to and extends away from the second end.

There has thus been outlined, rather broadly, the more important features of he disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a thread cleaner system according to an embodiment of the disclosure.

FIG. 2 is a right side view of an embodiment of the disclosure.

FIG. 3 is a front view of an embodiment of the disclosure.

FIG. 4 is a cross sectional view taken along line 4-4 of FIG. 3 of an embodiment of the disclosure.

FIG. 5 is a perspective in-use view of an embodiment of the disclosure.

### DESCRIPTION OF THE PREFERRED EMBODIMENT

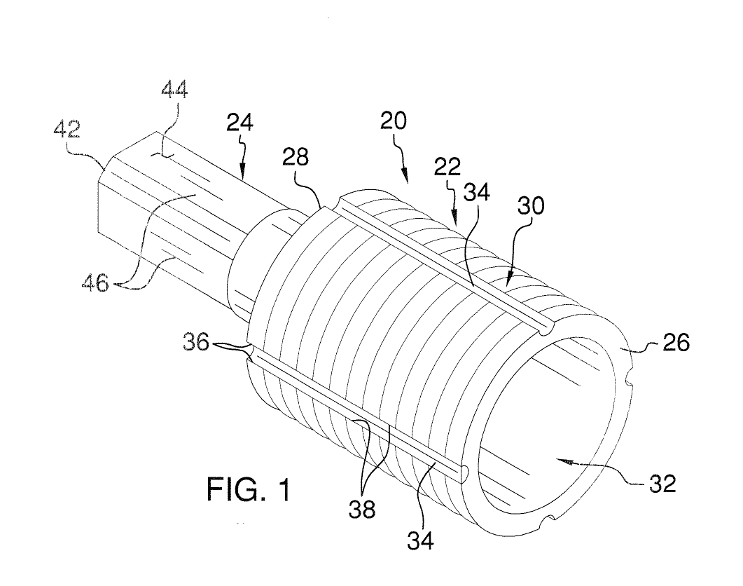

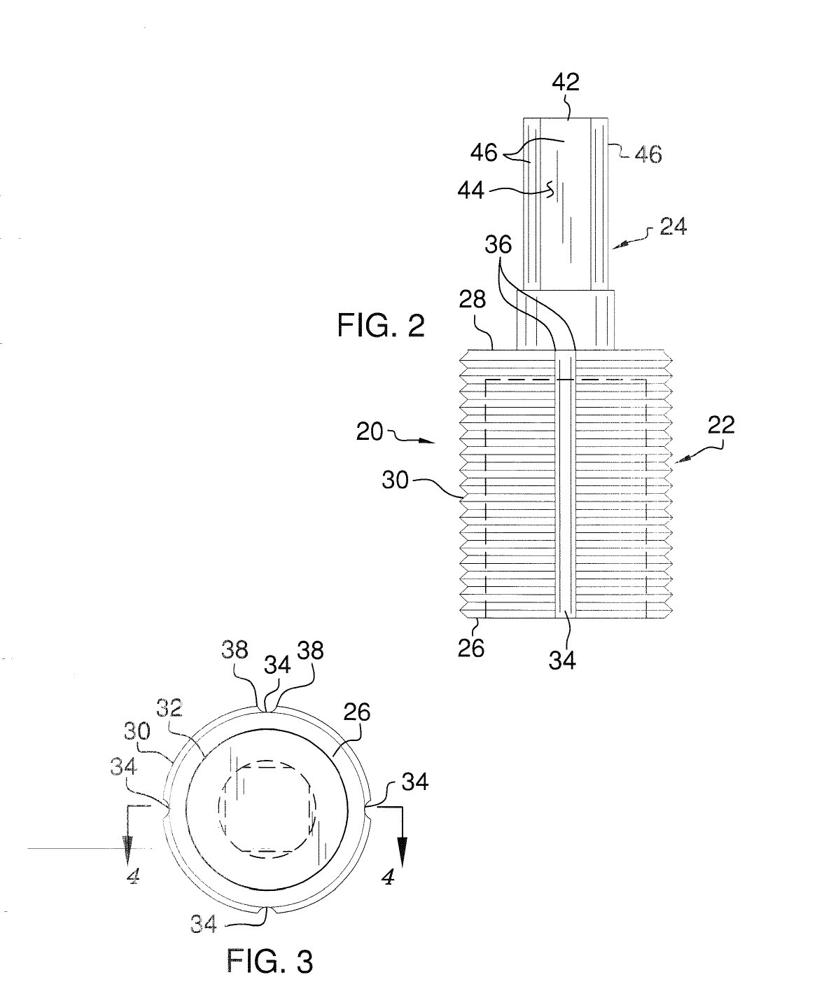

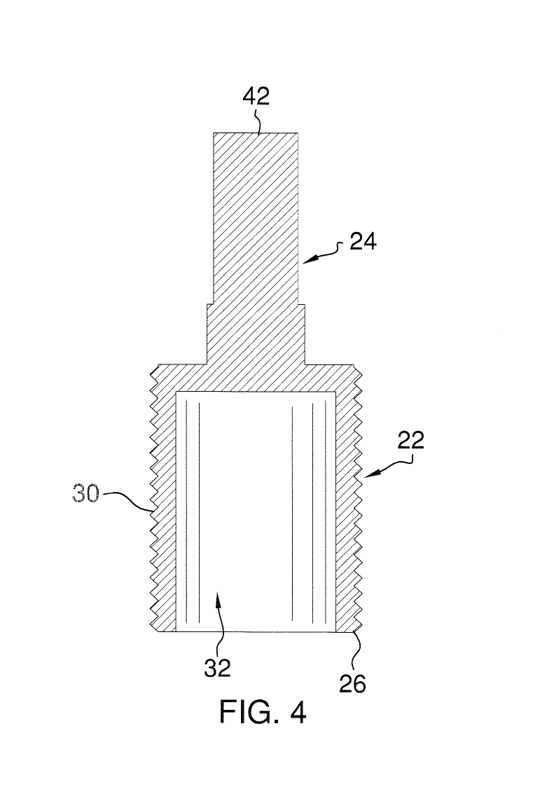

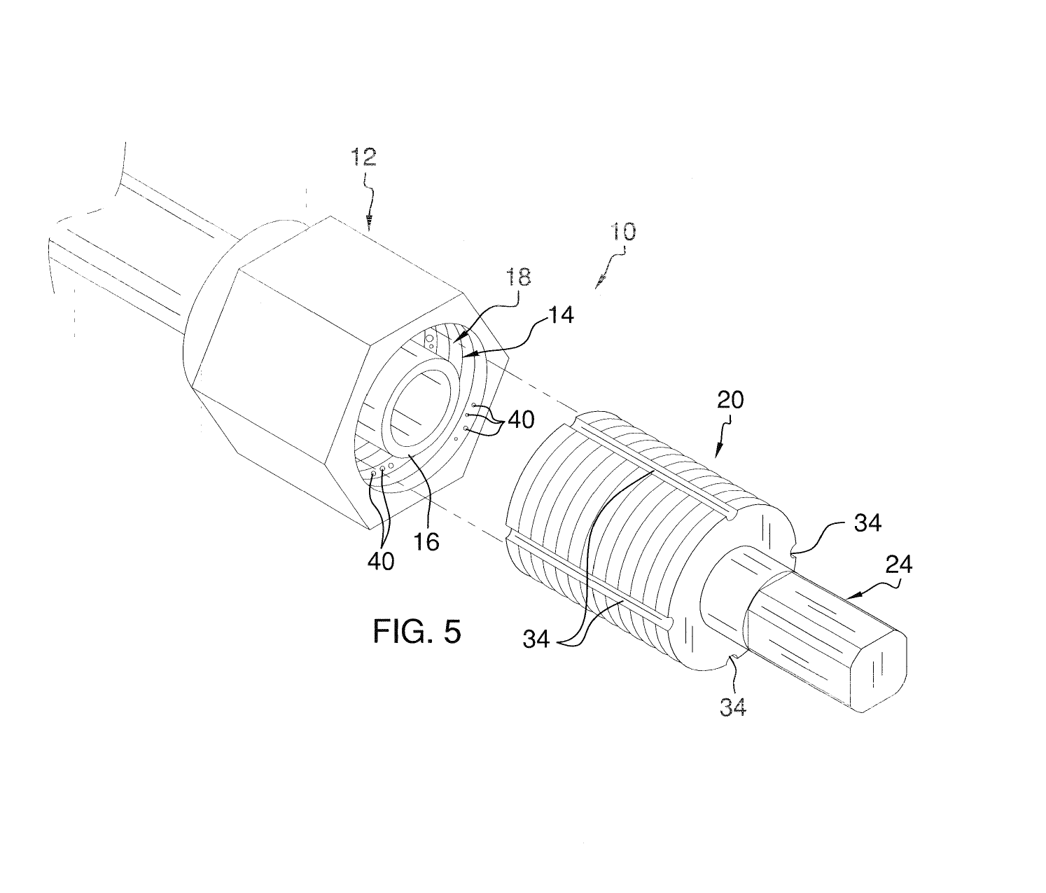

With reference now to the drawings, and in particular to FIGS. 1 through 5 thereof, a new cleaner device embodying the principles and concepts of an embodiment of the disclosure and generally designated by the reference numeral 10 will be described.

At best illustrated in FIGS. 1 through 5, the thread cleaner system 10 generally comprises a compression fitting 12 that has a well 14 and a tube 16. The well 14 has a bounding surface 18 and the bounding surface 18 is continuous such that the well 14 has a cylindrical shape. The bounding surface 18 is threaded and the tube 16 is centrally positioned within the well 14. The compression fitting 12 may be a compression fitting of any conventional design and the compression fitting 12 may come in a variety of sizes and diameters.

A cleaner 20 is provided. The cleaner 20 may be removably inserted into the compression fitting 12. The cleaner 20 may be rotated when the cleaner 20 is removably inserted into the compression fitting 12. Thus, the cleaner 20 cleans the compression fitting 12.

The cleaner 20 has a body portion 22 and a shaft portion 24. The body portion 22 has a first end 26, a second end 28 and a peripheral surface 30 extending between the first end 26 and the second end 28. The peripheral surface 30 is continuous such that the body portion 22 has a cylindrical shape. The first end 26 has a well 32 extending inwardly therein. The well 32 in the body portion 22 insertably receives the tube 16 when the body portion 22 is positioned within the well 14 in the compression fitting 12.

The peripheral surface 30 is threaded between the first end 26 and the second end 28 such that the peripheral surface 30 threadably engages the bounding surface 18. The peripheral surface 30 has a plurality of slots 34 and each of the slots 34 extends inwardly from the peripheral surface 30. Each of the slots 34 extends between the first end 26 and the second end 28. The slots 34 are spaced apart from each other and are distributed. around the body portion 22.

Each of the slots 34 has a pair of intersections 36 with respect to the threads on the body portion 22 and each of the intersections 36 of each of the slots 34 forms a cutting edge 38. The cutting edges 38 of each of the slots 34 remove debris 40 from the threads in the bounding surface 18 when the cleaner 20 is rotated in the compression fitting 12. Each of the slots 34 collects the debris 40 when the cleaner 20 is rotated in the compression fitting 12. Thus, the debris 40 may be removed from the compression fitting 12. The body portion 22 may be produced with a variety of sizes and diameters to accommodate the variety of sizes and diameters of the compression fitting 12. Additionally, the threads on the cleaner 20 may come in a variety of pitches and diameters.

The shaft portion 24 is coupled to and extends away from the second end 28 of the body portion 22. The shaft portion 24 has a distal end 42 with respect to the second end 28. The shaft portion 24 has an exterior surface 44 extending between the second end 28 and the distal end 42. The exterior surface 44 has a plurality of intersecting sides 46 such that the shaft portion 24 has a rectangular shape. Thus, the shaft portion 24 may be engaged by a wrench or the like thereby facilitating the cleaner 20 to be rotated in the compression fitting 12.

In use, the body portion 22 of the cleaner 20 is inserted into the well 14 in the compression fitting 12. The wrench or the like is positioned to engage the shaft portion 24 and the cleaner 20 is rotated in a clockwise direction such that the body portion 22 extends fully into the compression fitting 12. The slots 34 engage and remove the debris 40 from the threads in the compression fitting 12 as the cleaner 20 is threaded into the compression fitting 12. The cleaner 20 is rotated in a counterclockwise direction when the cleaner 20 is fully threaded into the compression fitting 12. The debris 40 that has collected in the slots 34 is removed from the compression fitting 12 thereby facilitating the compression fitting 12 to function properly.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may he resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A thread cleaner system comprising:
a compression fitting; and
a cleaner being removably inserted into said compression fitting, said cleaner being configured to be rotated when said cleaner is removably inserted into said compression fitting thereby facilitating said cleaner to clean said compression fitting, said shaft portion being coupled to and extending away from said second end.

2. The system according to claim 1, wherein said compression fitting has a well and a tube, said well having a bounding surface, said bounding surface being continuous such that said well has a cylindrical shape, said bounding surface being threaded, said tube being centrally positioned within said well.

3. The system according to claim 1, wherein said cleaner has a body portion and a shaft portion, said body portion having a first end, a second end and a peripheral surface extending between said first end and said second end, said peripheral surface being continuous such that said body portion has a cylindrical shape.

4. The system according to claim 3, wherein:
said compression fitting has a well; and
said first end has a well extending inwardly therein, said well in said body portion insertably receiving said tube when said body portion is positioned within said well in said compression fitting.

5. The system according to claim 4, wherein:
said well in said compression fitting has a bounding surface; and
said peripheral surface being threaded between said first end and said second end such that said peripheral surface threadably engages said bounding surface.

6. The system according to claim 3, wherein:
said compression fitting has a bounding surface, said bounding surface being threaded; and
said peripheral surface is threaded, said peripheral surface having a plurality of slots, each of said slots extending inwardly from said peripheral surface, each of said slots extending between said first end and said second end, said slots being spaced apart from each other and being distributed around said body portion.

1. The system according to claim 6, wherein each of said slots has a pair of intersections with respect to said threads, each of said intersections of each of said slots forms a cutting edge wherein said cutting edge of each of said slots is configured to remove debris from said threads in said bounding surface when said cleaner is rotated in said compression fitting, each of said slots being configured to collect the debris when said cleaner is rotated in said compression fitting thereby facilitating the debris to be removed from said compression fitting.

8. The system according to claim 3, wherein said shaft portion has a distal end with respect to said second end, said shaft portion having an exterior surface extending between said second end and said distal end.

9. The system according to claim 1, wherein said exterior surface has a plurality of intersecting sides such that said shaft portion has a rectangular shape wherein said shaft portion is configured to be engaged by a wrench thereby facilitating said cleaner to be rotated in said compression fitting.

10. A thread cleaner system comprising:
a compression fitting having a well and a tube, said well having a bounding surface, said bounding surface being continuous such that said well has a cylindrical shape, said bounding surface being threaded, said tube being centrally positioned within said well; and
a cleaner being removably inserted into said compression fitting, said cleaner being configured to be rotated when said cleaner is removably inserted into said compression fitting thereby facilitating said cleaner to clean said compression fitting, said cleaner having a body portion and a shaft portion, said body portion having a first end, a second end and a peripheral surface extending between said first end and said second end, said peripheral surface being continuous such that said body portion has a cylindrical shape, said first end having a well extending inwardly therein, said well in said body portion insertably receiving said tube when said body portion is positioned within said well in said compression fitting, said peripheral surface being threaded between said first end and said second end such that said peripheral surface threadably engages said bounding surface, said peripheral surface having a plurality of slots, each of said slots extending inwardly from said peripheral surface, each of said slots extending between said first end and said second end, said slots being spaced apart from each other and being distributed around said body portion, each of said slots having a pair of intersections with respect to said threads, each of said intersections of each of said slots forming a cutting edge wherein said cutting edge of each of said slots is configured to remove debris from said threads in said bounding surface when said cleaner is rotated in said compression fitting, each of said slots being configured to collect the debris when said cleaner is rotated in said compression fitting thereby facilitating the debris to be removed from said compression fitting, said shaft portion being coupled to and extending away from said second end, said shaft portion having a distal end with respect to said second end, said shaft portion having an exterior surface extending between said second end and said distal end, said exterior surface having a plurality of intersecting sides such that said shaft portion has a rectangular shape wherein said shaft portion is configured to be engaged by a wrench thereby facilitating said cleaner to be rotated in said compression fitting.
